(19) United States
(12) Patent Application Publication
(10) Pub. No.: US 2016/0231853 A1
(43) Pub. Date: Aug. 11, 2016

(54) TOUCH PANEL AND TOUCH DISPLAY DEVICE COMPRISING THE SAME

(71) Applicant: InnoLux Corporation, Miao-Li County (TW)

(72) Inventor: Tsan-Po WENG, Miao-Li County (TW)

(21) Appl. No.: 15/012,900

(22) Filed: Feb. 2, 2016

(30) Foreign Application Priority Data
Feb. 6, 2015 (CN) 201510061892.0

(51) Int. Cl. G06F 3/041

(52) U.S. Cl. CPC G06F 3/0416; G06F 3/0412

(57) ABSTRACT

A touch panel including a substrate having a first edge and a second edge adjacent to the first edge, wherein a central touch area and a first peripheral touch area are disposed on the substrate; a plurality of first touch electrodes disposed on the central touch area; a plurality of second and third touch electrodes disposed on the first peripheral touch area; and a fourth touch electrode disposed on the first peripheral touch area closest to an intersecting portion of the first edge and the second edge, wherein an area of at least one first touch electrode is greater than that of at least one second touch electrode and that of at least one third touch electrode, and an area of at least one second touch electrode and that of at least one third touch electrode are both greater than that of the fourth touch electrode.

### CROSS REFERENCE TO RELATED APPLICATION

This application claims the benefits of the Chinese Patent Application Serial Number 201510061892.0, filed on Feb. 6, 2015, the subject matter of which is incorporated herein by reference.

### BACKGROUND OF THE INVENTION

1. Field of the Invention

The present invention relates to a touch panel and particularly to a touch panel in which the linearity and touch precision of the periphery of the touch panel may be improved and the cutting ratio of panel glass may be increased to reduce the production cost of the panel.

2. Description of Related Art

In recent years, with the trend to the development of user-friendly and simplified operation technology, display devices with touch panels have been widely used in daily life. Since users can input signals by touching the touch panels with fingers or other articles, the users' dependence on other input devices, such as keyboards, mice, remote controllers, and the like, may be diminished or even eliminated. The convenience in operation can be drastically improved.

Conventionally, touch electrodes of a touch display panel have the same size. Accordingly, the touch electrodes in the periphery of the touch panel often encounter problems of poor linearity and precision. Thus, in some touch panels, the periphery of the touch panel is widened to solve the aforesaid problem. However, the widening will result in the reduction of the cutting ratio of panel glass and the cost for a single piece of glass will increase consequently.

Therefore, there is a need for an improved touch panel to solve the problems of poor peripheral linearity and precision as well as to increase glass cutting ratio to reduce production cost.

### SUMMARY OF THE INVENTION

An object of the present invention is to provide a touch panel, in which the area of a touch electrode disposed on a peripheral touch area is less than the area of a touch electrode disposed on a central touch area, to improve touch precision and to increase panel glass cutting ratio.

According to some embodiments, the touch panel comprises: a substrate having a first edge and a second edge adjacent to the first edge, and a central touch area and a first peripheral touch area outside the central touch area disposed on the substrate; a plurality of first touch electrodes disposed on the central touch area; a plurality of second touch electrodes disposed on the first peripheral touch area between the central touch area and the first edge; a plurality of third touch electrodes disposed on the first peripheral touch area between the central touch area and the second edge; and at least one fourth touch electrode disposed on the first peripheral touch area closest to an intersecting portion of the first edge and the second edge. An area of at least one of the first touch electrodes is greater than an area of at least one of the second touch electrodes, and the area of at least one of the first touch electrodes is greater than an area of at least one of the third touch electrodes. An area of at least one of the second touch electrodes is greater than an area of the fourth touch electrode, and an area of at least one of the third touch electrodes is greater than the area of the fourth touch electrode.

In a touch panel of an embodiment of the present invention, the first touch electrodes are arranged in an m×n array on the central touch area; the second touch electrodes are arranged in an m×n′ array on the first peripheral touch area between the central touch area and the first edge; the third touch electrodes are arranged in an m′×n array on the first peripheral touch area between the central touch area and the second edge; and the fourth touch electrode is or the fourth touch electrodes are arranged in an m′×n′ array on the first peripheral touch area closest to an intersecting portion of the first edge and the second edge. Each of m and n is an integer greater than 1, and each of m′ and n′ is an integer greater than or equal to 1. In some embodiments, m′ and n′ can be the same integer. In some embodiments, at least one of the second touch electrodes and at least one of the third touch electrodes can have the same area.

In a touch panel of an embodiment of the present invention, a border area is further disposed on the substrate outside the first peripheral touch area, and the touch panel may further comprise: a plurality of first border electrodes disposed on the border area between the first peripheral touch area and the first edge; a plurality of second border electrodes disposed on the border area between the first peripheral touch area and the second edge; and at least one third border electrode disposed on the border area closest to an intersecting portion of the first edge and the second edge. An area of at least one of the first border electrodes is greater than an area of the third border electrode, and an area of at least one of the second border electrodes is greater than an area of the third border electrode. An area of at least one of the first border electrodes may be less than or equal to an area of at least one of the second touch electrodes. An area of at least one of the second border electrodes may be less than or equal to an area of at least one of the third touch electrodes. An area of the third border electrode may be less than or equal to an area of the fourth touch electrode. In some embodiments, a ratio of a width of at least one of the first border electrodes to a width of at least one of the second touch electrodes is from 1:1 to 1:3; a ratio of a width of at least one of the second border electrodes to a width of at least one of the third touch electrodes is from 1:1 to 1:3; and/or a ratio of a width of the third border electrode to a width of the fourth touch electrode is from 1:1 to 1:3.

In a touch panel of an embodiment of the present invention, a second peripheral touch area may be further disposed on the substrate outside the first peripheral touch area and between the first peripheral touch area and the border area. The touch panel further comprises: a plurality of fifth touch electrodes disposed on the second peripheral touch area between the first peripheral touch area and the first edge; a plurality of sixth touch electrodes disposed on the second peripheral touch area between the first peripheral touch area and the second edge; and at least one seventh touch electrode disposed on the second peripheral touch area closest to an intersecting portion of the first edge and the second edge. An area of the seventh touch electrode is less than an area of at least one of the fifth touch electrodes, less than an area of at least one of the sixth touch electrodes, and less than an area of the at least one fourth touch electrode. In some embodiments, an area of at least one of the fifth touch electrodes and an area of at least one of the sixth touch electrodes can be the same.

In an embodiment, the fifth touch electrodes are arranged in an m×n″ array on the second peripheral touch area between the first peripheral touch area and the first edge; the sixth touch electrodes are arranged in an m″×n array on the second peripheral touch area between the first peripheral touch area and the second edge; and the seventh touch electrode is or the seven touch electrodes are arranged in an m″×n″ array on the second peripheral touch area closest to an intersecting portion of the first edge and the second edge. Each of m″ and n″ is an integer greater than or equal to 1. In some embodiments, m″ and n″ can be the same integer.

In a touch panel of an embodiment of the present invention, an area of at least one of the second touch electrodes may be greater or equal to an area of at least one of the fifth touch electrodes. In some embodiments, a ratio of a width of at least one of the fifth touch electrodes to a width of at least one of the second touch electrodes can be from 1:1 to 1:3. Likewise, in a touch panel of an embodiment of the present invention, an area of at least one of the third touch electrodes may be greater or equal to an area of at least one of the sixth touch electrodes. In some embodiments, a ratio of a width of at least one of the sixth touch electrodes to a width of at least one of the third touch electrodes can be from 1:1 to 1:3. In addition, in a touch panel of an embodiment of the present invention, an area of the fourth touch electrode may be greater or equal to an area of the seventh touch electrode. In some embodiments, a ratio of a width of the seven touch electrode to a width of the fourth touch electrode can be from 1:1 to 1:3.

In a touch panel of an embodiment of the present invention, a border area may be further disposed on the substrate outside the second peripheral touch area, and the touch panel may further comprise: a plurality of fourth border electrodes disposed on the border area between the second peripheral touch area and the first edge; a plurality of fifth border electrodes disposed on the border area between the second peripheral touch area and the second edge; and at least one sixth border electrode disposed on the border area closest to an intersecting portion of the first edge and the second edge. An area of at least one of the fourth border electrodes is greater than an area of the sixth border electrode, and an area of at least one of the fifth border electrodes is greater than an area of the sixth border electrode. In some embodiments, an area of at least one of the fourth border electrodes can be equal to an area of at least one of the fifth touch electrodes. Or, in some embodiments, an area of at least one of the fifth border electrodes can be equal to an area of at least one of the sixth touch electrodes. Or, in some embodiments, an area of the sixth border electrode can be equal to an area of the seventh touch electrode.

In a touch panel of an embodiment of the present invention, the pulse width for driving the fourth touch electrode is different from the pulse widths for driving the second touch electrodes and the third touch electrodes. The pulse widths for driving the second touch electrodes and the third touch electrodes are different from the pulse widths for driving the first touch electrodes. As a result, the final touch sensing signals perceived by the second touch electrodes, the third touch electrodes, and the fourth touch electrode are adjusted to be consistent with the touch sensing signals received by the first touch electrodes. Alternatively, a first gain is applied to a signal sensed by the first touch electrodes. A second gain is applied to a signal sensed by the second touch electrodes. A third gain is applied to a signal sensed by the third touch electrodes. A fourth gain is applied to a signal sensed by the fourth touch electrode. The fourth gain is different from each of the second gain and the third gain. The second gain and the third gain are each different from the first gain. The result is that the final touch sensing signals perceived by the second touch electrodes, the third touch electrodes, and the fourth touch electrode are adjusted to be consistent with the touch sensing signals received by the first touch electrodes. Alternatively, in addition to the utilization of different pulse widths for driving the first touch electrodes, the second touch electrodes, the third touch electrodes and the fourth touch electrode as described above, the first gain, the second gain, the third gain, and the fourth gain may be applied at the same time based on the signals sensed.

In a touch panel of an embodiment of the present invention, the peripheral linearity and precision may be improved through the disposition of touch electrodes in different sizes on the substrate. In particular, the area of the touch electrodes disposed on the peripheral touch area/areas is less than that of the touch electrodes disposed on the central touch area. Moreover, the touch electrode/electrodes closest to the intersecting portion of the two edges has/have the smallest area. In addition to the improvement of the peripheral linearity and precision, the panel glass cutting ratio may also be improved through the design in which the area of the border electrodes on the border area is less than that of the touch electrodes on the central touch area and the same as that of the touch electrodes on the peripheral touch area/areas. The additional utilization of different pulse widths for driving and the application of different gains may improve the resolution of coordinate reports to the system to improve touch precision. Furthermore, a touch display device is also provided in the present invention and it includes: a display panel; and a touch panel described above disposed on the display panel.

In the present invention, the type of display panel is not particularly limited. The display panel may be a liquid crystal display panel or an organic light-emitting diode display panel.

In the present invention, the “area” mentioned above means an area of a single touch electrode or a single border electrode. For example, an area of the first touch electrodes means an area of one of the first touch electrode.

Other objects, advantages, and novel features of the invention will become more apparent from the following detailed description when taken in conjunction with the accompanying drawings.

### BRIEF DESCRIPTION OF THE DRAWINGS

FIG. 1 is a top view of a touch panel of the Comparative Embodiment of the present invention;

FIG. 2 is a block diagram showing the operation of a touch panel of the Comparative Embodiment of the present invention;

FIG. 3 is a top view of a touch panel of Embodiment 1 of the present invention;

FIG. 4 is a schematic diagram showing the wiring for driving the touch electrodes of a touch panel of Embodiment 1 of the present invention;

FIG. 5 is a signal timing diagram of a touch panel of Embodiment 1 of the present invention;

FIG. 6 is a block diagram showing the operation of a touch panel of Embodiment 1 of the present invention;

FIG. 7 is a flow chart showing the operation of a touch panel of Embodiment 1 of the present invention;

FIG. 8 is a schematic top view of a touch panel of Embodiment 2 of the present invention; and

FIG. 9 is a schematic diagram of a touch display panel of Embodiment 3 of the present invention.

### DETAILED DESCRIPTION OF THE PREFERRED EMBODIMENT

The present invention will be further described by the following embodiments in detail. It will be apparent to those skilled in the art to understand other advantages and functions of the present invention in view of the content disclosed herein. The present invention may also be used or applied in other different embodiments. Modifications and variations of the present invention may be made in the light of different viewpoints and applications without departing from the spirit of the present invention.

### Comparative Embodiment

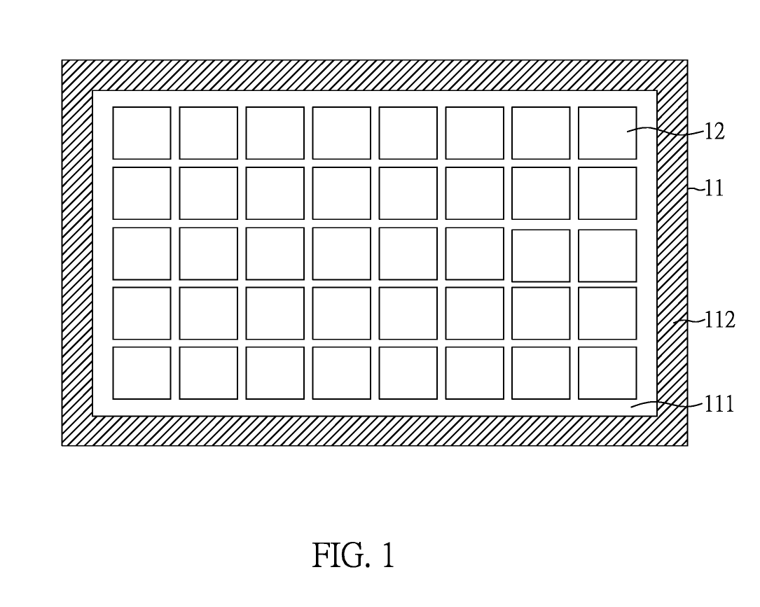

FIG. 1 is a top view of a touch panel of a Comparative Embodiment. In the touch panel of the Comparative Embodiment, a plurality of first touch electrodes 12 with the same size are disposed on a touch area 111 of a substrate 11. As a result, the pitch (or the spacing) between every first touch electrodes 12 is the same in the Comparative Embodiment. Herein, the term “pitch” means the distance between the centers of two adjacent first touch electrodes 12.

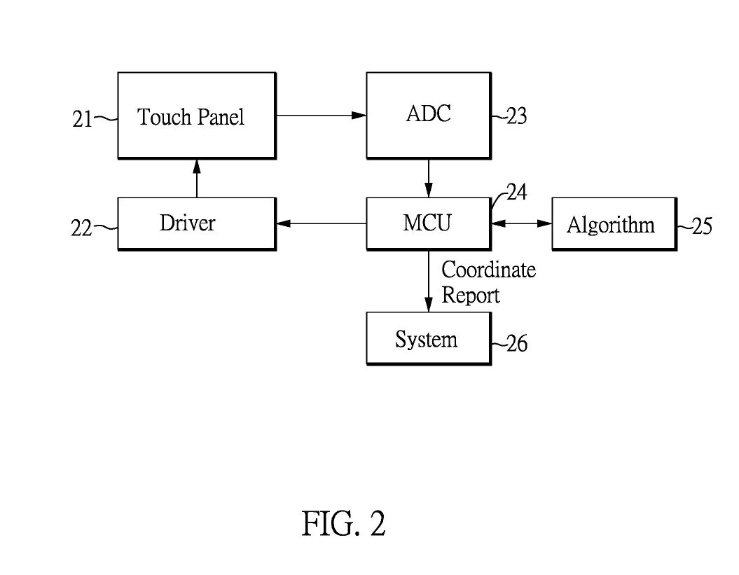

FIG. 2 is a block diagram showing the operation of a touch panel of the Comparative Embodiment. A microprocessor 24 (MCU) controls a driving circuit 22 to generate pulses for driving touch electrodes (not shown) in the touch panel 21. Thereafter, signals sensed by sensing electrodes (not shown) in the touch panel 21 are received by a digital-to-analog converter 23 (ADC) and then transferred to the microprocessor 24 (MCU). The calculation is performed through an algorithm 25. The resulting coordinates of points are reported to a system 26.

In the Comparative Embodiment, the touch panel as shown in FIG. 1 mainly works with a digital-to-analog converter having the same number of bits. However, with respect to the first touch electrodes 12 near a periphery area 112, no real point is calculated by the algorithm. Thus, the peripheral linearity and precision are reduced, resulting in unsatisfied quality of touch control. Accordingly, in the Comparative Embodiment, the periphery area 112 needs to have a certain width to solve the aforesaid problem to improve the quality of touch control. However, when the periphery area 112 has a certain width, the panel cutting ratio will be lowered and the cost of a single panel will be increased.

### Embodiment 1

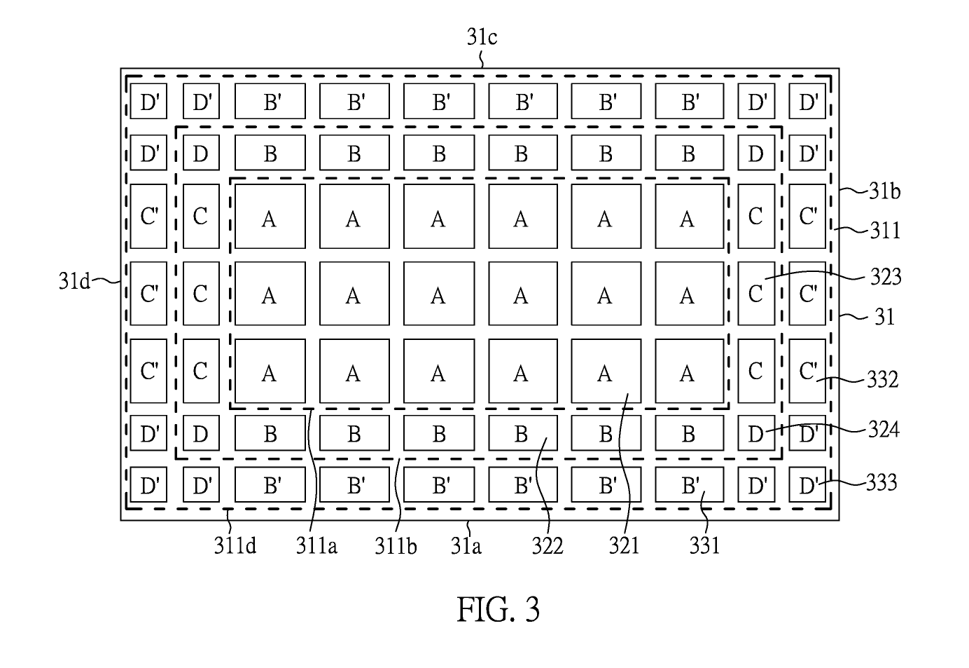

FIG. 3 is a top view of a touch panel of Embodiment 1 of the present invention. A touch panel of the present embodiment includes a substrate 31 having a surface 311 and a first edge 31a and a second edge 31b in which the first edge 31a is adjacent to the second edge 31b. A central touch area 311a and a first peripheral touch area 311b surrounding the central touch area 311a and outside the central touch area 311a are disposed on the surface 311 of the substrate 31. A plurality of first touch electrodes 321 are disposed on the substrate 31 and on the central touch area 311a. A plurality of second touch electrodes 322 are disposed on the substrate 31 and arranged on the first peripheral touch area 311b between the central touch area 311a and the first edge 31a. A plurality of third touch electrodes 323 are disposed on the substrate 31 and arranged on the first peripheral touch area 311b between the central touch area 311a and the second edge 31b. A plurality of fourth touch electrodes 324 are disposed on the substrate 31 and arranged on the first peripheral touch area 311b closest to an intersecting portion of the first edge 31a and the second edge 31b. The area of the first touch electrodes 321 can be greater than that of the second touch electrodes 322. The area of the second touch electrodes 322 can be greater than that of the fourth touch electrodes 324.

In the present embodiment, the area of the second touch electrodes 322 can be the same as that of the third touch electrodes 323. The only difference between the second touch electrodes 322 and the third touch electrodes 323 can be where the long sides and short sides of the rectangular touch electrodes are disposed. Nevertheless, these two areas may be different in other embodiments.

In addition, in the touch panel of the present embodiment, with respect to the width along the extension direction of the second edge 31b, the width of the second touch electrodes 322 (the touch electrodes represented by B) can be a half of the width of the first touch electrodes 321 (the touch electrodes represented by A). With respect to the width along the extension direction of the first edge 31a, the width of the third touch electrodes 323 (the touch electrodes represented by C) can be a half of the width of the first touch electrodes 321. With respect to the fourth touch electrodes 324 (the touch electrodes represented by D), the widths thereof along the extension directions of the first edge 31a and the second edge 31b can be both half of the widths of the first touch electrodes 321. Nonetheless, other embodiments of the present invention are not limited thereto.

In some embodiments, the area of at least one of the first touch electrodes 321 can be greater than the area of at least one of the third touch electrodes 323. The area of at least one of the second touch electrodes 322 can be greater than an area of the fourth touch electrode 324, and the area of at least one of the third touch electrodes 323 can be greater than the area of the fourth touch electrode 324.

In some embodiments, the area of the second touch electrodes 322 and the area of the third touch electrodes 323 are each from a half to one fourth of the area of the first touch electrodes 321, and the area of the fourth touch electrodes 324 can be from a half to one fourth of the area of the second touch electrodes 322 and from a half to one fourth of the area of the third touch electrodes 323. For example, the area of the second touch electrodes 322 and the area of the third touch electrodes 323 can be each a half of the area of the first touch electrodes 321, and the area of the fourth touch electrodes 324 can be a half of the area of the second touch electrodes 322 and a half of the area of the third touch electrodes 323.

In addition, in the touch panel of the present embodiment, the substrate 31 may further have a third edge 31c and a fourth edge 31d. The third edge 31c is opposite to the first edge 31a and the fourth edge 31d is opposite to the second edge 31b. Accordingly, the substrate 31 in the present embodiment can be rectangular. When the substrate 31 is rectangular, some of the fourth touch electrodes 324 are arranged on the first peripheral touch area 311b closest to the intersecting portion of the first edge 31a and the second edge 31b, some of the fourth touch electrodes 324 are arranged closest to the intersecting portion of the first edge 31a and the fourth edge 31d, some of the fourth touch electrodes 324 are arranged closest to the intersecting portion of the third edge 31c and the second edge 31b, and some of the fourth touch electrodes 324 are arranged closest to the intersecting portion of the third edge 31c and the fourth edge 31d.

In the touch panel of the present embodiment, the first touch electrodes 321 can be arranged in an m×n array on the central touch area 311a. The second touch electrodes 322 can be arranged in an m×n′ array on the first peripheral touch area 311b and in a region between the central touch area 311a and the first edge 31a and in a region between the central touch area 311a and the third edge 31c, respectively. The third touch electrodes 323 can be arranged in an m′×n array on the first peripheral touch area 311b and in a region between the central touch area 311a and the second edge 31b and in a region between the central touch area 311a and the fourth edge 31d, respectively. The fourth touch electrodes 324 can be arranged in an m′×n′ array on the first peripheral touch area 311b closest to the intersecting portion of the first edge 31a and the second edge 31b, the intersecting portion of the first edge 31a and the fourth edge 31d, the intersecting portion of the third edge 31c and the second edge 31b, and the intersecting portion of the third edge 31c and the fourth edge 31d. Each of m and n is an integer greater than 1 and each of m′ and n′ is an integer greater than or equal to 1. Furthermore, in some embodiments, m′ and n′ can be the same integer.

In other embodiments of the present invention, m, n, m′, and n′ are not limited to the numbers shown in FIG. 3. Instead, they can be adjusted according to the size of the touch panel and the touch precision. Nevertheless, the present invention is not limited thereto.

According to some embodiments, since the first touch electrodes 321, the second touch electrodes 322, the third touch electrodes 323, and the fourth touch electrodes 324 have different sizes, the pitch (or the spacing) between every first touch electrodes 321 is different from the pitch (or the spacing) between every second touch electrodes 322. The pitch (or the spacing) between every second touch electrodes 322 is also different from the pitch (or the spacing) between every fourth touch electrodes 324. Herein, the term “pitch (or the spacing)” means the distance between the centers of two adjacent touch electrodes.

Furthermore, a border area 311d can be further disposed on the substrate 31 surrounding the first peripheral touch area 311b and outside the first peripheral touch area 311b. Accordingly, the touch panel of the present embodiment further comprises: a plurality of first border electrodes 331 disposed on the border area 311d between the first peripheral touch area 311b and the first edge 31a and between the first peripheral touch area 311b and the third edge 31c; a plurality of second border electrodes 332 disposed on the border area 311d between the first peripheral touch area 311b and the second edge 31b and between the first peripheral touch area 311b and the fourth edge 31d; and a plurality of third border electrodes 333 disposed on the border area 311d closest to an intersecting portion of the first edge 31a and the second edge 31b, an intersecting portion of the first edge 31a and the fourth edge 31d, an intersecting portion of the third edge 31c and the second edge 31b, and an intersecting portion of the third edge 31c and the fourth edge 31d. An area of the first border electrodes 331 can be greater than that of the third border electrodes 333. An area of the second border electrodes 332 can be also greater than that of the third border electrodes 333.

Herein, the shape and area of the first border electrodes 331 (represented by B′) can be the same as those of the second touch electrodes 322 (represented by B). The shape and area of the second border electrodes 332 (represented by C′) can be the same as the third touch electrodes 323 (represented by C). The shape and area of the third border electrodes 333 (represented by D′) can be the same as the fourth touch electrodes 324 (represented by D). In other embodiments of the present invention, the area of the first border electrodes 331 may be from a half to one third of the area of the second touch electrodes 322. In other embodiments, the area of the first border electrodes 331 can be from a half to one third of the area of the second touch electrodes 322. The area of the second border electrodes 332 can be from a half to one third of the area of the third touch electrodes 323. The area of the third border electrodes 333 can be from a half to one third of the area of the fourth touch electrodes 324.

In other embodiments, a ratio of the width of the first border electrodes 331 to the width of the second touch electrodes 322 can be from 1:1 to 1:3. A ratio of the width of the second border electrodes 332 to the width of the third touch electrodes 323 can be from 1:1 to 1:3. A ratio of the width of at least one third border electrode 333 to the width of at least one fourth touch electrode 324 can be from 1:1 to 1:3. The width mentioned above can be the width along the extension direction of the first edge 31a or the second edge 31b.

When the touch panel of the present embodiment works with a digital-to-analog converter having the same number of bits, since the area of the second touch electrodes 322, the third touch electrodes 323, and the fourth touch electrodes 324 on the first peripheral touch area 311b are less than the area of the first touch electrodes 321, and the area of the first border electrodes 331, the second border electrodes 332, and the third border electrodes 333 on the border area 311d are less than the area of the first touch electrodes 321, the peripheral linearity and precision of the touch panel can be improved to achieve satisfied touch quality without widening the periphery area as done in Comparative Embodiment. Thereby, compared to the touch panel of Comparative Embodiment, the panel glass cutting ratio can be improved and the cost for a single panel can be reduced.

In the present embodiment, the first touch electrodes 321, the second touch electrodes 322, the third touch electrodes 323, and the fourth touch electrodes 324 have different areas. The touch signals can be adjusted according to the area sizes of the touch electrodes, in order to adjust the final touch sensing signals perceived by the second touch electrodes 322, the third touch electrodes 323, and the fourth touch electrodes 324 to be consistent with the touch sensing signals perceived by the first touch electrodes 321. Likewise, the first touch electrodes 321, the first border electrodes 331, the second border electrodes 332, and the third border electrodes 333 also have different sizes. The final sensing signals perceived by the first border electrodes 331, the second border electrodes 332, and the third border electrodes 333 can be adjusted to be consistent with the touch sensing signals perceived by the first touch electrodes 321. For example, in order to achieve good touch quality, different gains can be applied in accordance with the calculation of algorithm, different driving waveforms, or adjustment of the sensed signals.

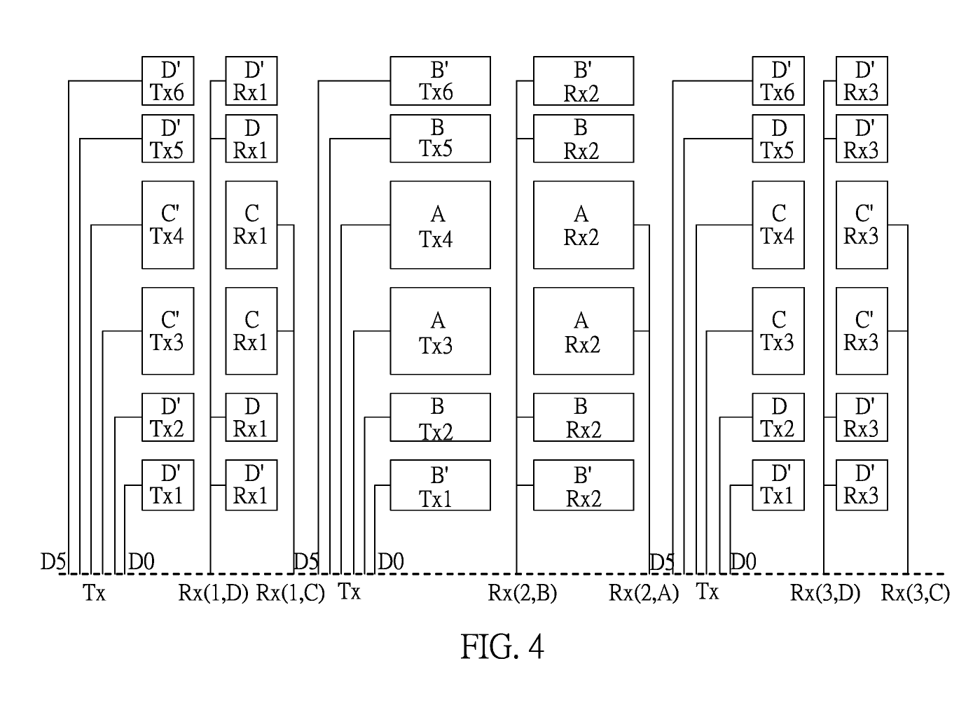

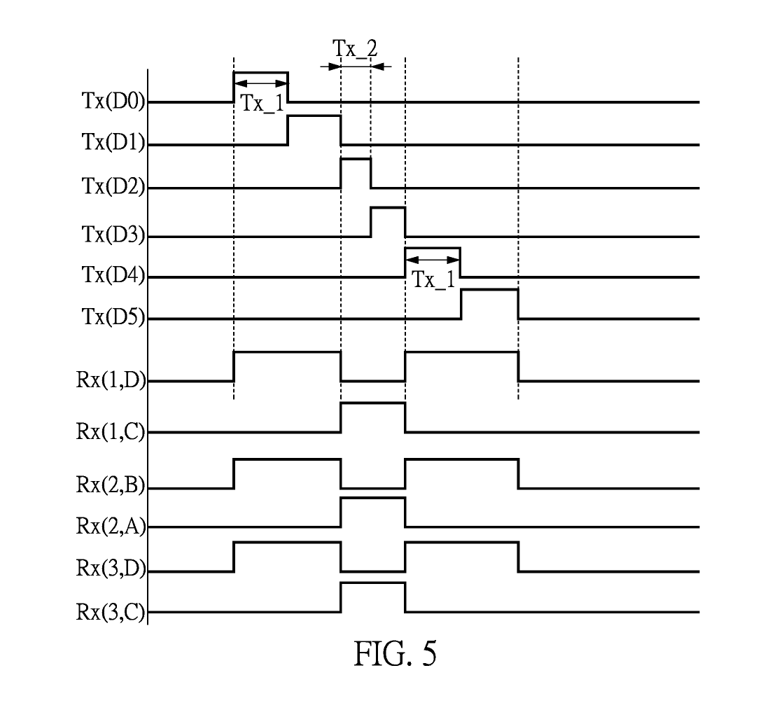

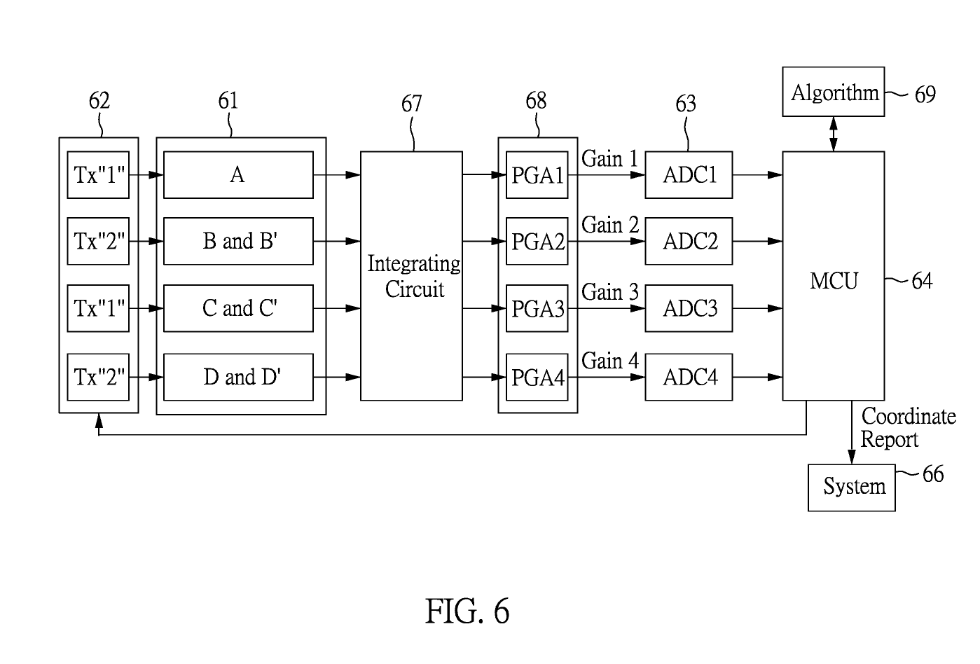

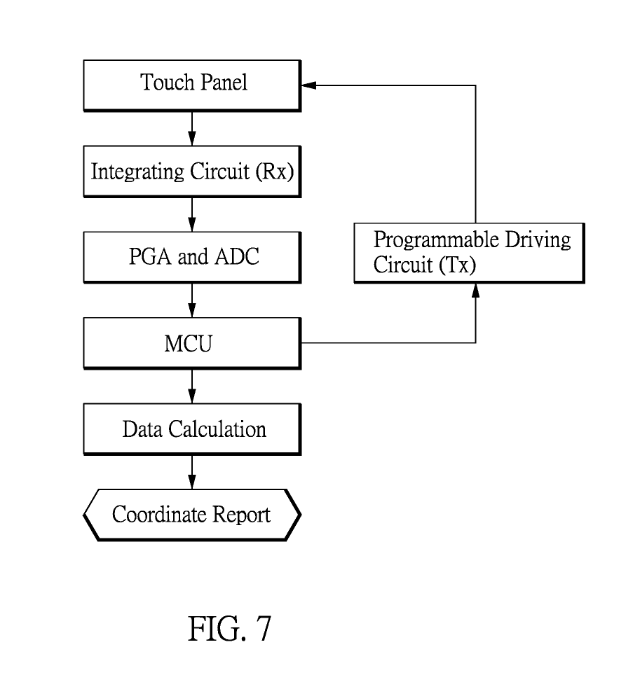

Please refer to FIGS. 3-7. FIG. 4 is a schematic diagram showing the wiring for driving the touch electrodes of the touch panel of the present embodiment. FIG. 5 is a signal timing diagram of the touch panel of the present embodiment. FIG. 6 is a block diagram showing the operation of the touch panel of the present embodiment. FIG. 7 is a flow chart showing the operation of the touch panel of the present embodiment. Herein, for clearer explanation, in FIGS. 3-7, the first touch electrodes 321 on the central touch area 311a are each represented by A; the second touch electrodes 322 on the first peripheral touch area 311b between the central touch area 311a and the first edge 31a and between the central touch area 311a and the third edge 31c respectively are each represented by B; the third touch electrodes 323 on the first peripheral touch area 311b between the central touch area 311a and the second edge 31b and between the central touch area 311a and the fourth edge 31d respectively are each represented by C; and the fourth touch electrodes 324 on the first peripheral touch area 311b closest to the intersecting portion of the first edge 31a and the second edge 31b, the intersecting portion of the first edge 31a and the fourth edge 31d, the intersecting portion of the third edge 31c and the second edge 31b, and the intersecting portion of the third edge 31c and the fourth edge 31d are each represented by D. In addition, for clearer explanation, in FIGS. 3-7, the first border electrodes 331 on the border area 311d between the first peripheral touch area 311b and the first edge 31a and between the first peripheral touch area 311b and the third edge 31c respectively are each represented by B′; the second border electrodes 332 on the border area 311d between the first peripheral touch area 311b and the second edge 31b and between the first peripheral touch area 311b and the fourth edge 31d respectively are each represented by C′; and the third border electrodes 333 on the border area 311d closest to the intersecting portion of the first edge 31a and the second edge 31b, the intersecting portion of the first edge 31a and the fourth edge 31d, the intersecting portion of the third edge 31c and the second edge 31b, and the intersecting portion of the third edge 31c and the fourth edge 31d are each represented by D′. Furthermore, some electrodes A, A′, B, B′, C, C′, D, and D′ shown in FIG. 3 are omitted in FIG. 4 and FIG. 5. Nonetheless, the person skilled in the art may understand that FIGS. 3-5 are just schematic diagrams and the amount of touch electrodes included by the touch panel can be adjusted in accordance with, for example, panel size, panel area, touch precision, and so forth.

As shown in FIGS. 4-6, a driving circuit 62 is connected to the electrodes B, B′, D, and D′ of the touch panel 61 through signal transmission lines Tx(D0), Tx(D1), Tx(D4), and Tx(D5) and connected to the electrodes A, C, and C′ of the touch panel 61 through signal transmission lines Tx(D2) and Tx(D3). An integrating circuit 67 is connected to the electrodes D, D′, and C near the fourth edge 31 of the touch panel as shown in FIG. 3 through signal receiving lines Rx(1,D) and Rx(1,C), respectively, connected to the electrodes B, B′, and A of the touch panel through signal receiving lines Rx(2,B) and Rx(2,A), respectively, and connected to the electrodes D′ and C′ near the second edge 31b of the touch panel as shown in FIG. 3 through signal receiving lines Rx(3,D) and Rx(3,C), respectively.

As shown in FIG. 4 and FIG. 5, in the driving circuit 62, driving pulses are provided to electrodes A, B, B′, C, C′, D, and D′ through Tx(D0) to Tx(D5), respectively. The driving pulses with different pulse widths can be provided in accordance with the sizes of the electrodes A, B, B′, C, C′, D, and D′. This is to adjust the final touch sensing signals perceived by the second touch electrodes 322, the third touch electrodes 323, and the fourth touch electrodes 324 to be consistent with the touch sensing signals received by the first touch electrodes 321. This is also to adjust the final sensing signals perceived by the first border electrodes 331, the second border electrodes 332, and the third border electrodes 333 to be consistent with the touch sensing signals received by the first touch electrodes 321 at the same time.

In the present embodiment, driving pulses with a pulse width Tx_1 are provided to the electrodes D and D′ through Tx(D0), Tx(D 1), Tx(D4), and Tx(D5). Driving pulses with a pulse width Tx_2 are provided to the electrodes C and C′ through Tx(D2) and Tx(D3).

In some embodiments, a pulse width for driving at least one fourth touch electrode 324 (D) is different from a pulse width for driving the second touch electrodes 322 (B) and a pulse width for driving the third touch electrodes 323 (C). A pulse width for driving the second touch electrodes 322 (B) and a pulse width for driving the third touch electrodes 323 (C) are different from a pulse width for driving the first touch electrodes 321 (A).

In some embodiments, the area of the electrodes D and D′ is less than that of the electrodes C and C′, the pulse width Tx_1 provided to the electrodes D and D′ can be adjusted to be greater than the pulse width Tx_2 provided to the electrodes C and C′. In some embodiments, the area of the electrodes D and D′ can be a half of the area of the electrodes C and C′, the pulse width Tx_1 can be adjusted to be two times of the pulse width Tx_2. Likewise, in some embodiments, driving pulses with a pulse width Tx_1 can be provided to the electrodes B and B′ through Tx(D0), Tx(D1), Tx(D4), and Tx(D5). Driving pulses with a pulse width Tx_2 can be provided to the electrode A through Tx(D2) and Tx(D3). The area of the electrodes B and B′ can be a half of the area of the electrode A. Accordingly, the pulse width Tx_1 can be adjusted to be two times of the pulse width Tx_2.

Accordingly, as shown in FIG. 3 and FIG. 5, in the present embodiment, when the corresponding third touch electrodes 323 (electrodes C), fourth touch electrodes 324 (electrodes D), second border electrode 332 (electrodes C′), and third border electrodes 333 (electrodes D′) are considered, the pulse widths driving the fourth touch electrodes 324 and the third border electrode 333 (electrodes D and D′) can be greater than the pulse widths driving the third touch electrodes 323 and the second border electrode 332 (electrodes C and C′). When the corresponding first touch electrodes 321 (electrodes A), second touch electrodes 322 (electrodes B), and first border electrodes 331 (electrodes B′) are considered, the pulse widths driving the second touch electrodes 322 (touch electrodes B) and the first border electrode 331 (electrodes B′) can be greater than the pulse width driving the first touch electrode 321 (electrodes A).

Regarding the receiving of the touch electrode signals, as shown in FIG. 4 and FIG. 5, when the electrodes D′ as shown on the left side of the drawing are being driven, Rx(1,D) senses and receives the touch signals of its adjacent electrodes D and D′. When the electrodes C′ as shown on the left side of the drawing are being driven, Rx(1,C) senses and receives the touch signals of its adjacent electrodes C. When the electrodes B and B′ are being driven, Rx(2,B) senses and receives the touch signals of the electrodes B and B′. When the electrodes A are being driven, Rx(2,A) senses and receives the touch signals of the electrodes A. When the electrodes D and D′ as shown on the right side of the drawing are being driven, Rx(3,D) senses and receives the touch signals of its adjacent electrodes D′. When the electrodes C as shown on the right side of the drawing are being driven, Rx(3,C) senses and receives the touch signals of its adjacent electrodes C′.

Thereafter, in order to adjust the final touch sensing signals perceived by the second touch electrodes 322, the third touch electrodes 323, the fourth touch electrodes 324, the first border electrodes 331, the second border electrodes 332, and the third border electrodes 333 to be consistent with the touch sensing signals received by the first touch electrodes 321, different gains may be applied to the touch sensing signals sensed in accordance with the sizes of the touch electrodes A, B, B′, C, C′, D, and D′. As shown in FIG. 6 and FIG. 7, when the integrating circuit 67 receives the touch signals of Rx(1,C), Rx(1,D), Rx(2,A), Rx(2,B), Rx(3,C), and Rx(3,D), it converts the charge signals sensed into voltage signals. The voltage signals are then transferred to a programmable gain amplifier 68 (PGA). At this time, as shown by FIGS. 3 and 5-7, a first gain (Gain 1) is applied to a sensing signal sensed by the first touch electrodes 321 (the touch electrodes A). A second gain (Gain 2) is applied to a sensing signal sensed by the second touch electrodes 322 and the first border electrodes 331 (the electrodes B and B′). A third gain (Gain 3) is applied to a sensing signal sensed by the third touch electrodes 323 and the second border electrodes 332 (the electrodes C and C′). A fourth gain (Gain 4) is applied to a sensing signal sensed by the fourth touch electrode 324 and the third border electrodes 333 (the electrodes D and D′). With regards to the corresponding electrodes C, C′, D, and D′, the fourth gain (Gain 4) can be greater than the third gain (Gain 3). With regards to the corresponding electrodes A, B, and B′, the second gain (Gain 2) can be greater than the first gain (Gain 1).

As shown in FIG. 5 and FIG. 6, the final touch sensing signals perceived by the second touch electrodes 322, the third touch electrodes 323, the fourth touch electrodes 324, the first border electrodes 331, the second border electrodes 332, and the third border electrodes 333 can be adjusted to be consistent with the touch sensing signals received by the first touch electrodes 321 through the adjustments of driving waveform and the application of different gains with respect to the sensing signals sensed.

Thereafter, as shown in FIG. 6 and FIG. 7, the signals after the gains have been applied are converted by a digital-to-analog converter 63 (ADC) and then transferred to a microprocessor 64 (MCU). The data are calculated through an algorithm 69 and the resulting coordinates of points are reported to a system 66. Herein, the microprocessor 64 further controls the driving circuit 62 in order to adjust the pulse widths of the touch electrodes.

In the touch panel of the present embodiment, the touch precision can be improved through the dynamic control of switching the pulse widths of the touch electrodes in combination with the applied gains.

### Embodiment 2

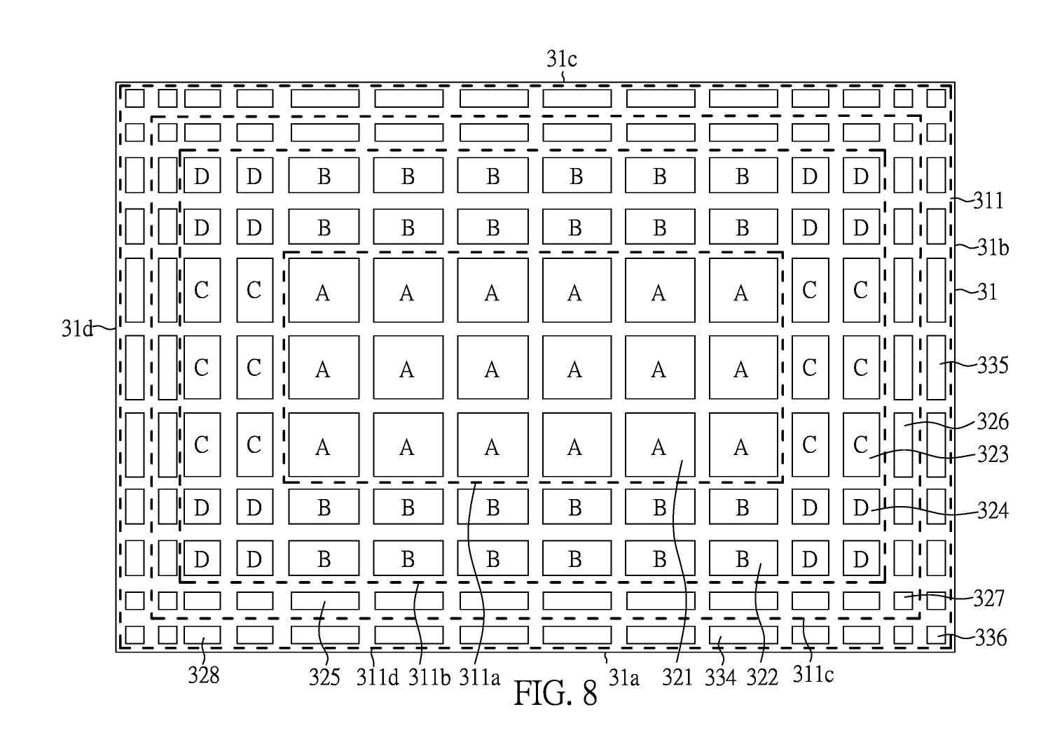

As shown in FIG. 8, the structure and the driving mode of the touch panel in the present embodiment is similar to that of Embodiment 1. However, the touch panel of the present embodiment further includes a second peripheral touch area 311c surrounding the first peripheral touch area 311b and disposed outside the first peripheral touch area 311b. The second peripheral touch area 311c can be between the first peripheral touch area 311b and the border area 311d. Accordingly, the touch panel of the present embodiment further includes: a plurality of fifth touch electrodes 325 disposed on the second peripheral touch area 311c between the first peripheral touch area 311b and the first edge 31a; a plurality of sixth touch electrodes 326 disposed on the second peripheral touch area 311c between the first peripheral touch area 311b and the second edge 31b; and at least one seventh touch electrode 327 disposed on the second peripheral touch area 311c closest to an intersecting portion of the first edge 31a and the second edge 31b.

In some embodiments, the plurality of fifth touch electrodes 325 are disposed on the substrate 31 and arranged on the second peripheral touch area 311c between the first peripheral touch area 311b and the first edge 31a and between the first peripheral touch area 311b and the third edge 31c. The plurality of sixth touch electrodes 326 are disposed on the substrate 31 and arranged on the second peripheral touch area 311c between the first peripheral touch area 311b and the second edge 31b and between the first peripheral touch area 311b and the fourth edge 31d. The plurality of seventh touch electrodes 327 are disposed on the substrate 31 and arranged on the second peripheral touch area 311c closest to an intersecting portion of the first edge 31a and the second edge 31b, an intersecting portion of the first edge 31a and the fourth edge 31d, an intersecting portion of the third edge 31c and the second edge 31b, and an intersecting portion of the third edge 31c and the fourth edge 31d. The area of the second touch electrodes 322 can be greater than that of the fifth touch electrodes 325. The area of the third touch electrodes 323 can be greater than that of the sixth touch electrodes 326. The area of the fourth touch electrodes 324 can be greater than that of the seventh touch electrodes 327. The area of the first touch electrodes 321 can be greater than each of the area of the fifth touch electrodes 325 and the area of the sixth touch electrodes 326. Each of the area of the fifth touch electrodes 325 and the area of the sixth touch electrodes 326 can be greater than the area of the seventh touch electrodes 327.

Furthermore, in the touch panel of the present embodiment, the fifth touch electrodes 325 can be arranged in an m×n” array on the second peripheral touch area 311c between the first peripheral touch area 311b and the first edge 31a and the third edge 31c, respectively. The sixth touch electrodes 326 can be arranged in an m″×n array on the second peripheral touch area 311c between the first peripheral touch area 311b and the second edge 31b and the fourth edge 31d, respectively. The seventh touch electrodes 327 can be arranged in an m″×n″ array on the second peripheral touch area 311c closest to an intersecting portion of the first edge 31a and the second edge 31b, an intersecting portion of the first edge 31a and the fourth edge 31d, an intersecting portion of the third edge 31c and the second edge 31b, and an intersecting portion of the third edge 31c and the fourth edge 31d. Each of m″ and n″ can be an integer greater than or equal to 1. Herein, the numbers of m″ and n″ are not particularly limited to the numbers shown in FIG. 8. They can be adjusted in accordance with the sizes of the touch panel and the touch precision. Nevertheless, the present invention is not limited thereto.

In addition, in the touch panel of the present embodiment, a border area 311d can be further disposed on the substrate 31 outside the second peripheral touch area 311c. Accordingly, the touch panel of the present embodiment further includes: a plurality of fourth border electrodes 334 disposed on the border area 311d between the second peripheral touch area 311c and the first edge 31a and the third edge 31c, respectively; a plurality of fifth border electrodes 335 disposed on the border area 311d between the second peripheral touch area 311c and the second edge 31b and the fourth edge 31d, respectively; and a plurality of sixth border electrodes 336 disposed on the border area 311d closest to an intersecting portion of the first edge 31a and the second edge 31b, an intersecting portion of the first edge 31a and the fourth edge 31d, an intersecting portion of the third edge 31c and the second edge 31b, and an intersecting portion of the third edge 31c and the fourth edge 31d. Each of the area of the fourth border electrodes 334 and the area of the fifth border electrodes 335 can be greater than that of the sixth border electrodes 336.

In addition, in the touch panel of the present embodiment, a ratio of a width of the fifth touch electrode 325 to a width of the second touch electrode 322 along the extension direction of the second edge 31b can be from 1:1 to 1:3. For example, this ratio can be 1:2. In addition, a ratio of a width of the sixth touch electrode 326 to a width of the third touch electrode 323 along the extension direction of the first edge 31a can be from 1:1 to 1:3. For example, this ratio can be 1:2. In addition, a ratio of a width of the seventh touch electrode 327 to a width of the fourth touch electrode 324 along each extension direction of the first edge 31a and the second edge 31b can be from 1:1 to 1:3. For example,this ratio can be 1:2.

In addition, in the touch panel of the present embodiment, a ratio of a width of the fourth border electrode 334 to a width of the fifth touch electrode 325 can be from 1:1 to 1:3. A ratio of a width of the fifth border electrode 335 to a width of the sixth touch electrode 326 can be from 1:1 to 1:3. A ratio of a width of the sixth border electrode 336 to a width of the seventh touch electrode 327 can be from 1:1 to 1:3. In the present embodiment, the shape and area of the fourth border electrodes 334 can be the same as those of the fifth touch electrodes 325. The shape and area of the fifth border electrodes 335 can be the same as those of the sixth touch electrodes 326. The shape and area of the sixth border electrodes 336 can be the same as those of the seventh touch electrodes 327.

In the aforesaid Embodiments 1 and 2 of the present invention, rectangular touch panels are taken as examples; however, other embodiments of the present invention are not limited thereto. In other embodiments of the present invention, the substrates may be in other shapes, such as pentagons, hexagon, and so forth. The only limitation is that the touch electrodes disposed on the first peripheral touch area and/or the second peripheral touch area closest to an intersecting portion of two edges have smaller shapes than the first touch electrodes on the central touch area.

### Embodiment 3

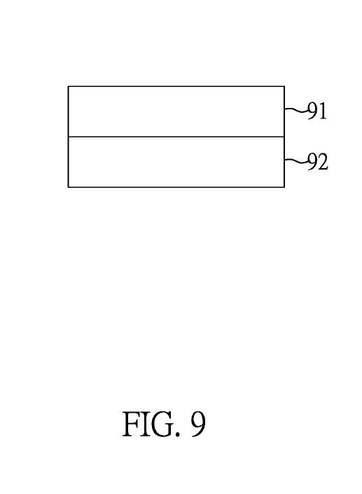

As shown in FIG. 9, the present embodiment provides a touch display device including a display panel 92 and a touch panel 91 disposed on the display panel 92. The touch panel 91 may be one of the touch panels described above in the aforesaid embodiments. The display panel 92 may be a conventional display panel, such as a liquid crystal display panel or an organic light-emitting diode display panel.

The touch panel and the display panel made in the aforesaid embodiments of the present invention may be applied to any conventional electronic devices requiring touch control function, especially to touch display devices, such as display devices, mobile phones, notebooks, video cameras, cameras, music players, portable navigation devices, televisions, and so forth.

Although the present invention has been explained in relation to its preferred embodiments, it is to be understood that many other possible modifications and variations can be made without departing from the spirit and scope of the invention as hereinafter claimed.

What is claimed is:

1. A touch panel comprising:
a substrate having a first edge and a second edge adjacent to the first edge, wherein a central touch area and a first peripheral touch area outside the central touch area are disposed on the substrate;
a plurality of first touch electrodes disposed on the central touch area;
a plurality of second touch electrodes disposed on the first peripheral touch area between the central touch area and the first edge;
a plurality of third touch electrodes disposed on the first peripheral touch area between the central touch area and the second edge; and
at least one fourth touch electrode disposed on the first peripheral touch area closest to an intersecting portion of the first edge and the second edge;
wherein an area of at least one of the first touch electrodes is greater than an area of at least one of the second touch electrodes, and the area of at least one of the first touch electrodes is greater than an area of at least one of the third touch electrodes; and an area of at least one of the second touch electrodes is greater than an area of the fourth touch electrode, and an area of at least one of the third touch electrodes is greater than the area of the fourth touch electrode.

2. The touch panel as claimed in claim 1, wherein the first touch electrodes are arranged in an m×n array on the central touch area; the second touch electrodes are arranged in an m×n′ array on the first peripheral touch area between the central touch area and the first edge; the third touch electrodes are arranged in an m′×n array on the first peripheral touch area between the central touch area and the second edge; and the fourth touch electrodes are arranged in an m′×n′ array on the first peripheral touch area closest to an intersecting portion of the first edge and the second edge, wherein each of m and n is an integer greater than 1, and each of m′ and n′ is an integer greater than or equal to 1.

3. The touch panel as claimed in claim 1, wherein a border area is further disposed on the substrate outside the first peripheral touch area, and the touch panel further comprises:
a plurality of first border electrodes disposed on the border area between the first peripheral touch area and the first edge; and
a plurality of second border electrodes disposed on the border area between the first peripheral touch area and the second edge;
at least one third border electrode disposed on the border area closest to an intersecting portion of the first edge and the second edge;
wherein each of an area of at least one of the first border electrodes and an area of at least one of the second border electrodes is greater than an area of the third border electrode.

4. The touch panel as claimed in claim 1, wherein a second peripheral touch area is further disposed on the substrate outside the first peripheral touch area and between the first peripheral touch area and the border area, and the touch panel further comprises:
a plurality of fifth touch electrodes disposed on the second peripheral touch area between the first peripheral touch area and the first edge;
a plurality of sixth touch electrodes disposed on the second peripheral touch area between the first peripheral touch area and the second edge; and
at least one seventh touch electrode disposed on the second peripheral touch area closest to an intersecting portion of the first edge and the second edge;
wherein an area of the seventh touch electrode is less than each of an area of at least one of the fifth touch electrodes, an area of at least one of the sixth touch electrodes, and an area of the fourth touch electrode.

5. The touch panel as claimed in claim 3, wherein a ratio of a width of the first border electrodes to a width of the second touch electrodes is from 1:1 to 1:3.

6. The touch panel as claimed in claim 3, wherein a ratio of a width of the second border electrodes to a width of the third touch electrodes is from 1:1 to 1:3.

7. The touch panel as claimed in claim 3, wherein a ratio of a width of at least one third border electrode to a width of at least one fourth touch electrode is from 1:1 to 1:3.

8. The touch panel as claimed in claim 1, wherein a pulse width for driving at least one fourth touch electrode is different from a pulse width for driving the second touch electrodes and a pulse width for driving the third touch electrodes.

9. The touch panel as claimed in claim 1, wherein a pulse width for driving the second touch electrodes and a pulse width or driving the third touch electrodes are different from a pulse width for driving the first touch electrodes.

10. A touch display device, comprising:
a display panel; and
a touch panel disposed on the display panel, which comprises:
a substrate having a first edge and a second edge adjacent to the first edge, wherein a central touch area and a first peripheral touch area outside the central touch area are disposed on the substrate;
a plurality of first touch electrodes disposed on the central touch area;
a plurality of second touch electrodes disposed on the first peripheral touch area between the central touch area and the first edge;
a plurality of third touch electrodes disposed on the first peripheral touch area between the central touch area and the second edge; and
at least one fourth touch electrode disposed on the first peripheral touch area closest to an intersecting portion of the first edge and the second edge,
wherein an area of at least one of the first touch electrodes is greater than an area of at least one of the second touch electrodes, and the area of at least one of the first touch electrodes is greater than an area of at least one of the third touch electrodes; and an area of at least one of the second touch electrodes is greater than an area of the fourth touch electrode, and an area of at least one of the third touch electrodes is greater than the area of the fourth touch electrode.
